(19) United States
(12) Patent Application Publication
(10) Pub. No.: US 2019/0378176 A1
(43) Pub. Date: Dec. 12, 2019

(54) SYSTEMS AND METHODS FOR CUSTOMIZING DISPLAY ON DIGITAL BILLBOARD

(71) Applicant: Walmart Apollo, LLC, Bentonville, AR (US)

(72) Inventor: John J. O'Brien, Farmington, AR (US)

(21) Appl. No.: 16/433,293

(22) Filed: Jun. 6, 2019

Related U.S. Application Data
(60) Provisional application No. 62/682,561, filed on Jun. 8, 2018.

(51) Int. Cl. G06Q 30/02; G06K 9/00

(52) U.S. Cl. CPC G06Q 30/0276; G06Q 30/0261; G06Q 50/01; G06K 9/00288; G06Q 30/0271; G06Q 30/0267

(57) ABSTRACT

Systems, apparatuses, and methods are provided herein for providing customized advertisement display on a digital billboard. A system comprises a digital billboard device with a customer sensor, a communication device, an advertisement database, and a control circuit. If the customer has opted into an advertisement service and has reviewed appropriate privacy disclosures and authorized the use of his or her social media data by registering a consent to customer social media data capture by the system, the control circuit is configured to identify a customer via the customer sensor, aggregate a plurality of images associated with the customer from a plurality of social media services, identify one or more characteristics of each of the plurality of images, select an advertisement from the advertisement database, select at least one customer image based on matching the display parameters of the advertisement in the advertisement database with the one or more characteristics of the plurality of images, merge the at least one customer image and an image of the advertisement to create a custom image advertisement for the customer, and display the custom image advertisement to the customer.

### CROSS-REFERENCE TO RELATED APPLICATION

This application claims the benefit of U.S. Provisional Application No. 62/682,561, filed Jun. 8, 2018, which is incorporated herein by reference in its entirety.

### TECHNICAL FIELD

These teachings relate generally to digital billboards.

### BACKGROUND

Billboards are widely used for advertisements in public spaces such as roadsides, shopping areas, stores, and malls. Some traditional billboards are now replaced with digital billboards that include display screens for displaying preprogrammed content. Typically, a digital billboard is programmed to cycles through a set number of advertisements on repeat.

### BRIEF DESCRIPTION OF THE DRAWINGS

Disclosed herein are embodiments of systems and methods for advance order payment processing. This description includes drawings, wherein:

FIG. 1 comprises a system diagram in accordance with several embodiments;

FIG. 2 comprises a block diagram in accordance with several embodiments;

FIG. 3 comprises a block diagram in accordance with several embodiments; and

FIG. 4 comprises a flow diagram in accordance with several embodiments; and

FIG. 5 comprises a process diagram in accordance with several embodiments.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present teachings. Also, common but well-understood elements that are useful or necessary in a commercially feasible embodiment are often not depicted in order to facilitate a less obstructed view of these various embodiments of the present teachings. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

Generally speaking, pursuant to various embodiments, systems, apparatuses and methods are provided for providing customized advertisement display. A system for providing customized advertisement display comprises a digital billboard device comprising a customer sensor, a communication device configured to communicate with a plurality of social media services, an advertisement database storing a plurality of advertisements and display parameters associated with each of the plurality of advertisements, and a control circuit coupled to the digital billboard device, the communication device, and the advertisement database. The control circuit being configured to identify a customer near the digital billboard device via the customer sensor, aggregate a plurality of images associated with the customer from the plurality of social media services via the communication device, identify one or more characteristics of each of the plurality of images associated with the customer, select an advertisement from the advertisement database to display to the customer, select at least one customer image from the plurality of images associated with the customer based on matching the display parameters of the advertisement in the advertisement database with the one or more characteristics of the plurality of images, merge the at least one customer image and an image of the advertisement to create a custom image advertisement for the customer, and display the custom image advertisement to the customer via the digital billboard device.

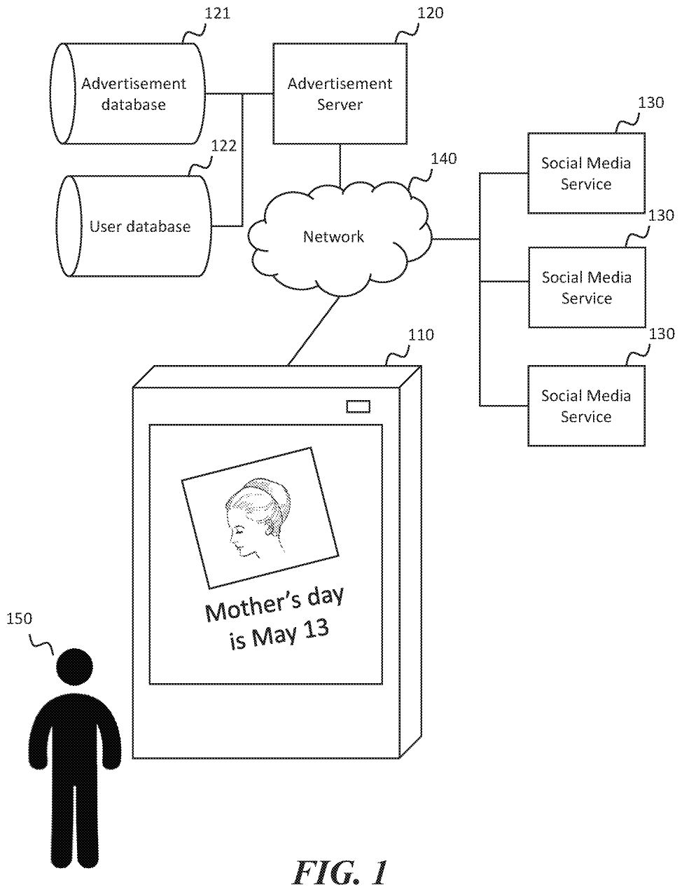

Referring now to FIG. 1, a system diagram according to some embodiments is shown. The system comprises a digital billboard device 110 displayed to a user 150 and communicating with a plurality of social media services 130 and an advertisement server 120 coupled to an advertisement database 121 and a user database 122.

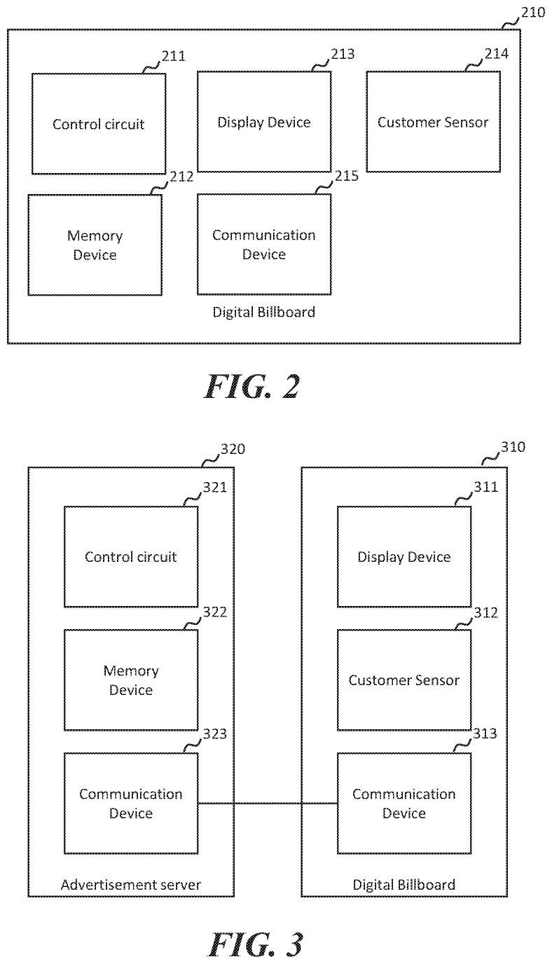

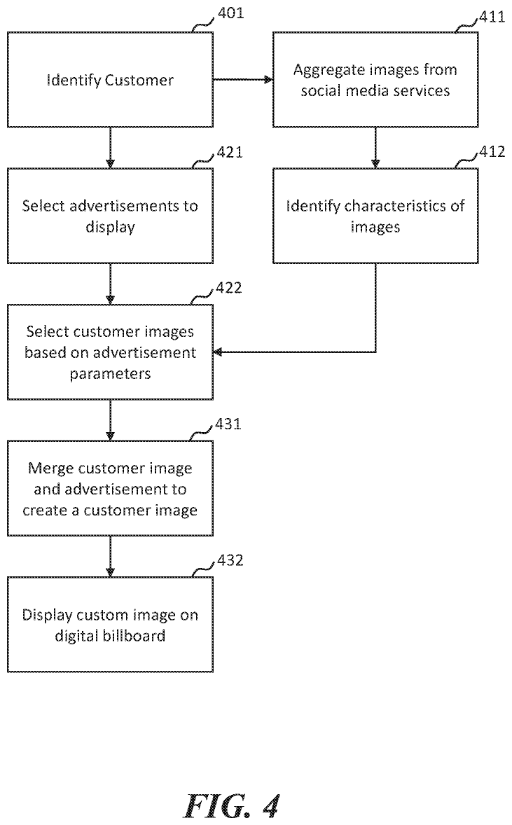

The digital billboard device 110 generally comprises a display device placed in a public space to display information and/or advertisement to be viewed by a plurality of users 150. In some embodiments, the digital billboard device 110 comprises a processor and a memory device, and the processor is configured to identify the user 150 and display content customized to the user 150. In some embodiments, the customized content includes an image retrieves from the user's social media network. In some embodiments, the digital billboard device 110 comprises a customer sensor configured to detect a presence of a sensor. In some embodiments, the digital billboard comprise one or more display devices such as liquid crystal display (LCD), light emitting diode (LED) displays, organic LED (OLED) displays, projection displays, and the like. In some embodiments, the digital billboard may further comprise user input devices such as a touch screen, a motion sensor, a keyboard, etc. for interacting with users. In some embodiments, the digital billboard device may communicate with the advertisement server 120 and/or the social media services 130 over a network 140 to display content to users via a display. The size and dimension of the digital billboard device 110 in FIG. 1 is provided for illustration only. Digital billboard devices 110 may be of various sizes and shapes without departing from the spirit of the present invention. In some embodiments, a digital billboard device 110 may comprise a plurality of display screens. For example, a digital billboard device 110 may have screens on both the front side and the back side. In some embodiments, the digital billboard device 110 may comprise a projection display instead of a screen. Further details of a digital billboard device 110 according to some embodiments are described with reference FIGS. 2 and 3 herein. In some embodiments, the digital billboard device 110 may be configured to perform one or more steps described with reference to FIG. 4 herein.

The advertisement server 120 generally comprises a server device configured to provide advertisement and associated information to the digital billboard device. In some embodiments, the advertisement server 120 may comprise a retail management server, a remote server, a cloud-based server, a central computer system, and the like. In some embodiments, the advertisement server 120 comprises a processor and a memory device. In some embodiments, the advertisement server 120 is configured to maintain a database of advertisements in the advertisement database 121. The advertisement database 121 stores a plurality of advertisements and display parameters associated with each of the plurality of advertisements. In some embodiments, the display parameters associated with each of the plurality of advertisements comprise one or more of required customer image characteristics, preferred customer image characteristics, customer image insertion location, and the like. In some embodiments, the advertisement server is further configured to maintain user data in the user database 122. For example, the user database 122 may store user accounts, user device associations, user social media handle, user social media access credential, previously aggregated user social media images, user relationships, user shopping histories, user digital billboard preferences, permissions, etc. In some embodiments, the advertisement server 120 may be configured to aggregate and analyze images from the social media services 130. In some embodiments, the advertisement server may further be configured to perform image processing and provide combined images to the digital billboard device 110 for display. Further detail of an advertisement server 120 according to some embodiments is described with reference to FIG. 3 herein. In some embodiments, the advertisement server 120 may be configured to perform one or more steps described with reference to FIG. 4 herein. In some embodiments, the advertisement server 120 may comprise a cloud server implemented on the processors of a plurality of digital billboard devices and/or other devices.

The social media services 130 may generally comprise web-based content sharing platforms. In some embodiments, the social media services 130 may comprise content, text, and/or image sharing services that allow users to upload, share, and/or comment on content with their account. In some embodiments, content associated with user accounts may comprise private and/or public content. Examples of social media services may comprise Facebook, Twitter, Instagram, Snapchat, Pinterest, Tumblr, LinkedIn, Google+, Flickr, and the like. The digital billboard device 110 and/or the advertisement server 120 may generally be configured to access contents on one or more social media services via the network 140. In some embodiments, the network 140 may comprise one or more of a private network, a secure network, a virtual private network, a public network, the Internet, and the like that allows devices on the network to communicate with each other.

While only one digital billboard device 110 is shown, in some embodiments, an advertisement server 120 may simultaneously support a plurality of digital billboard devices 110 in displaying content to users. In some embodiments, the advertisement server 120 may select and generate the advertisement content for the digital billboard device 110 to display without further processing. In some embodiments, the advertisement server 120 may only provide the advertisement to be combined with a customer image at the digital billboard device 110. In some embodiments, the advertisement server 120 may be absent and the digital billboard device 110 may select advertisements, retrieve customer images, and combine images for display locally. In some embodiments, a plurality of digital billboard device 110 may collective track the movement of customers in a public space such as a retail store or a shopping mall. The system may anticipate a customer's arrival at a particular billboard and begin to generate a customized advertisement prior to the customer's arrival. In some embodiments, a group of billboard devices may collectively analyze customer social media images to generate customized advertisement. For example, billboards that are idle and not currently engaging a customer may provide processing power to analyze social media images and generate customized advertisements for other digital billboards in the system to display.

While three social media services 130 are shown in FIG. 3, the system may be configured to retrieve information from any number of social media services. While the advertisement database 121 and the user database 122 are shown to be external to the advertisement server 120, in some embodiments, the advertisement database 121 and/or the user database 122 may be implemented on the memory device of the advertisement server 120. In some embodiments, at least a portion of the advertisement database 121 and/or the user database 122 may be implemented on the memory device of the digital billboard device 110.

Referring now to FIG. 2, a block diagram of a digital billboard device 210 according to some embodiments is shown. The digital billboard device 210 comprises a control circuit 211, a memory device 212, a display device 213, a communication device 215, and a customer sensor 214. In some embodiments, the digital billboard devices 210 may comprise the digital billboard device 110 or a similar device.

The control circuit 211 may comprise a processor, a central processor unit, a microprocessor, and the like. The memory device 212 may include one or more of a volatile and/or non-volatile computer readable memory devices. In some embodiments, the memory device 212 stores computer executable codes that cause the control circuit 211 to identify customers via the customer sensor 214, communicate with social media servers via the communication device 215, and display advertisements using customer social media images via the display device 213. In some embodiments, the control circuit 211 may further be configured to select an advertisement based on the identified user and select a user social media image based on the parameters of the advertisement. In some embodiments, the control circuit 211 may be configured to perform one or more steps described with reference to FIG. 4 herein. The memory device 212 may further store one or more of customer profile, advertisement content, advertisement display parameters, and customized advertisement images. In some embodiments, the advertisement database 121 and the user database 122 may be partially stored on the memory device 212 of the digital billboard device 210. In some embodiments, the digital billboard device 210 may be configured to pre-download at least some advertisements and store the advertisements for later use.

The display device 213 generally comprises a digital display configured to present images to customers. In some embodiments, the display device may comprise an LCD, a LED display, an OLED display, a projection display, and the like. In some embodiments, a digital billboard device 210 may comprise a plurality of display device 213. In some embodiments, the digital billboard device 210 may comprise other user input/output devices such as a speaker, a microphone, a motion sensor, a gesture sensor, a touch screen, a touchpad, and the like.

The communication device 215 generally comprises a device configured to allow the digital billboard device 210 to communicate with one or more of an advertisement server, a remote advertisement database, and one or more social media services over a network. In some embodiments, the communication device 215 may comprise a network adapter, a network port, a data port, a wireless network transceiver, a cellular data transceiver, and the like.

The customer sensor 214 generally comprises a device configured to detect and collect identifying information from a customer. In some embodiments, the customer sensor 214 may comprise one or more of an optical sensor, a presence sensor, a radio frequency identification (RFID) sensor, a near field communication (NFC) transceiver, a Wi-Fi transceiver, a Bluetooth transceiver, and the like. In some embodiments, the customer sensor 214 may comprise a camera, and the system may be configured to perform facial recognition to identify the customer. In some embodiments, the customer sensor 214 may comprise a wireless transceiver configured to communicate with a mobile device carried by the customer to identify the customer. In some embodiments, the customer sensor 214 may be configured to communicate with the mobile device via a mobile application installed on the mobile device, and the mobile application may allow the customer to opt-in and/or opt-out of the custom image advertisement. In some embodiments, the customer sensor 214 may be configured to communicate the custom image advertisement and/or information associated with an advertised product to the mobile device.

In some embodiments, the digital billboard device 210 may perform one or more of the steps described with reference to FIG. 4 independently, based on communications with an advertisement server, and/or collectively with a group of similar digital billboard devices.

Referring now to FIG. 3, a block diagram of an advertisement server 320 with a thin-client digital billboard device 310 is shown. The digital billboard device 310 comprises a display device 311, a customer sensor 312, and communication device 313. The display device 311, the customer sensor 312, and the communication device 313 may be similar to the display device 213, the customer sensor 214, and the communication device 215 described with reference to FIG. 2, respectively. In some embodiments, the digital billboard device 310 may comprise a low power processor or an application-specific integrated circuit (ASIC) control circuit for displaying content. In some embodiments, the digital billboard devices 310 may comprise the digital billboard device 110 or a similar device.

The advertisement server 320 generally comprises a server that is configured to provide information for the display of customized advertisements on the digital billboard device 310. The advertisement server 320 comprises a control circuit 321, a memory device 322, and a communication device 323. The control circuit 321 may comprise a processor, a central processor unit, a microprocessor, and the like. The memory device 322 may include one or more of a volatile and/or non-volatile computer readable memory devices. In some embodiments, the memory device 322 stores computer executable codes that cause the control circuit 321 to identify customers based on information received from the digital billboard, communicate with social media servers via the communication device 323, generate customized advertisement, and communicate the customized image to the digital billboard device 310 for display. In some embodiments, the control circuit 321 may further be configured to select an advertisement based on the identified user and select a user social media image based on the parameters of the advertisement. In embodiments, the control circuit 321 may be configured to perform one or more steps described with reference to FIG. 4 herein. The memory device 322 may store one or more of customer profile, advertisement content, advertisement display parameters, and customized advertisement images. In some embodiments, the advertisement database 121 and the user database 122 may be partially stored on the memory device 322 of the digital billboard device 310. In some embodiments, the advertisement server 320 may select and generate the advertisement content for the digital billboard device 310 to display without further processing. In some embodiments, the advertisement server 320 may only provide the advertisement to be combined with a customer image at the digital billboard device 110. In some embodiments, the advertisement server 320 may be configured to aggregate and analysis user social media images for one or more digital billboard devices 110.

Referring next to FIG. 4, a method for providing customized advertisement display with a digital billboard is shown. In some embodiments, the steps in FIG. 4 may be performed by a digital billboard device, a group of digital billboard devices, and/or an advertisement server. In some embodiments, the steps in FIG. 4 may be performed by one or more of advertisement server 120, the digital billboard device 110, the digital billboard device 210, the advertisement server 320, and the digital billboard device 310 or similar devices.

In step 401, the system identifies a customer near the digital billboard device via the customer sensor. In some embodiments, prior to step 401, the customer may opt-in to the advertisement service through a website or a mobile application. For example, the customer may sign up for the service and link his/her social media accounts with the advertisement/retail services to authorize the use of their social media images. In some embodiments, the system may determine whether the customer is a registered user in step 401 and only proceed to step 421 and 422 if the customer has given permission.

The systems and methods described herein can be configured to comply with privacy requirements which may vary between jurisdictions. For example, before any recording, collection, capturing or processing of customer data, a “consent to capture” process may be implemented. In such a process, consent may be obtained, from the customer, via a registration process. Part of the registration process may be to ensure compliance with the appropriate privacy laws for the location where the service would be performed. The registration process may include certain notices and disclosures made to the customer prior to the customer giving consent. In other words, the exemplary systems and methods described herein provide for no unauthorized/unconsented to collection or processing of data of customers.

In some embodiments, after registration, and before collection or processing of customer data, the system verifies that the customer as registered with the system and has provides the required consent for data collection. That is, the customer's registration status as having consented to the collection of the customer's data can be verified by the system prior to collecting any customer data. This verification can take place, for example, by the customer entering a PIN (Personal Identification Number), password, or other code into a keypad or keyboard; by the customer entering into a limited geofence location while carrying a fob, mobile device (such as a smartphone), or other RF transmitter, where the device has been configured to broadcast an authorization signal.

In some embodiments, once consent is verified, customer data can be captured, processed and used. Absent verification of consent, the customer data collection features of the system remain inactive. Once consent is verified, customer data collection features of the system may be activated. In some aspects, if the system detects that customer data was inadvertently collected from the customer prior to verification of that customer's consent to the data collection, such collected data is immediately deleted, not having been saved to disk.

In some embodiments, customer data captured as part of the verification process is handled and stored by a single party at a single location. In some aspects, where data must be transmitted to an offsite location for verification, certain disclosures prior to consent are required, and the customer data is encrypted. The hashing of the customer data received is a form of asymmetrical encryption which improves both data security and privacy, as well as reducing the amount of customer data which needs to be communicated.

In some embodiments, the data being shared by the user can be changed by the user at any time. In one aspect, after the user opts in to share data, the user receives a notification of the active sharing relationship, for example, what information is being shared and how it will be used, as well as information on how to review and manage the user's active and inactive data sharing relationships. In some embodiments, the specifics of all active and inactive data sharing relationships of the user are provided to the user for review and/or modification within a data sharing relationship management interface.

Storing records on a blockchain is appealing due to the difficulty in modifying records and data already stored on the blockchain. In some aspects, a private key and a public key are needed to access a particular block or blockchain data, and the private key which is unique to a user is needed to generate a new action on the blockchain such as sending a permitted and targeted advertisement or another marketing message. In some embodiments, if customer profile data accessed by the digital billboard were stored on the blockchain, the private key of the customer would be needed to view/modify the records which could include both information to help advertisers or other marketers send relevant messages and directions or limitations on how, when, and where those messages may be sent. In certain aspects, the private key for the customer profile data of a given customer could be owned and controlled by the customer. The private key could also be managed by a trusted entity such as a trusted retailer or a trusted consultant whereby the trusted entity will handle data in accord with customer instructions, and the blockchain serves to track advertiser and other marketer interactions.

In one embodiment, a customer may include data created by the customer based on what the customer knows he or she prefers without further guidance. In another embodiment, the customer may incorporate data given to that customer by one or more retailers that would allow an advertiser or another marketer to predict products and promotions that would appeal to the customer. In yet another embodiment, the customer may include spatial, temporal, or material restrictions such as to allow advertisements for food products when encountering a digital billboard inside the store that the customer shops but not at other times and places. In still another embodiment, the customer may include data that is being collected in real time by a connected device whereby the advertiser or another marketer could combine both the customer profile data and shopping basket data to solicit the purchase of products that fit the customer profile data and the data from the present shopping basket.

In some embodiments, the customer is allowed to manage his or her customer profile data actively where he or she is keying or uploading specific data to the profile detailing information and permissions. In some aspects, the customer is also allowed to upload data passively whereby the blockchain customer profile data may receive additional data from a retailer about purchase histories that the retailer is adept at mining and that only requires the permissions and restrictions of the customer from which to allow targeted advertisements or other marketing messages. In certain implementations, the private key and public key work together so the customer can control what is in his or her customer profile data and how an advertiser or another marketer can use that data. In some embodiments, the customer receives solicitations for products and services the customer is more likely to need or want when and where the customer is more likely to need or want those products and services, and an advertiser or another marketer using the digital billboard can use the public key to access the customer profile data and verify that it is the customer profile data set up by the customer to receive advertisements and other marketing messages.

In some embodiments, the system may use facial recognition to identify the customer and match the customer to a user profile. In some embodiments, the customer sensor may comprise a camera system that tracks the movement of customers in a retail space. In some embodiments, the system may detect a customer via a user device carried by the customer. For example, the customer sensor may detect for one or more of a mobile phone, a smartphone, a smartwatch, a wearable device, RFID card, and the like. In some embodiments, the customer sensor may comprise a data transceiver that establishes communication with the user device to collect identifying information of the customer. In some embodiments, the system may send a message to the user via the user device or the display screen of the digital billboard device to request for permission to use their social media images prior to proceeding.

In step 411, the system aggregates a plurality of images associated with the customer from the plurality of social media services via a communication device. In some embodiments, the social media services correspond to social media services that the customer has linked with his/her account. Social media services may generally refer to content sharing platforms that allow users to upload, share, and/or comment on content with their account. In some embodiments, content associated with user accounts may comprise private and/or public content. Examples of social media services may comprise Facebook, Twitter, Instagram, Pinterest, Tumblr, LinkedIn, Google+, Flickr, Snapchat, and the like. In some embodiments, the system may only aggregate publicly accessible content on the user's social media account in step 411. In some embodiments, the system may aggregate images uploaded by the customer, images associated with the customer (e.g. tagged, mentioned), and/or images uploaded or associated with accounts linked with the customer (e.g. friends, family, relatives). In some embodiments, the system may only aggregate recent image (e.g. within the last year, last 2 months, etc.) In some embodiments, the system may only aggregate featured images such as profile images, cover images, etc. In some embodiments, the customer may configure the permission for aggregating different types of images from their social media accounts (e.g. profile photo only, my photos only, photos I am tagged in, etc.)

In step 412, the system identifies one or more characteristics of each of the plurality of images associated with the customer aggregated in step 411. In some embodiments, the one or more characteristics are identified based on one or more of facial recognition, object recognition, and image metadata analysis. In some embodiments, the system may use annotations (e.g. description, tags, hashtags) and/or comments associated with the image to determine image characteristics. For example, if an image received multiple comments with the word “engagement,” the system may determine that the photo is an engagement announcement. In some embodiments, the one or more characteristics of a customer image comprise one or more of persons, objects, date, location, event, associated with the customer image. In some embodiments, the one or more characteristics of a customer image comprise a relationship with a person in the customer image as determined based on the customer's social media profile connections. For example, the system may identify a person in a social media image as the customer's mother based on their social media connections and/or the labeling of the image (e.g. photo tags).

In some embodiments, steps 411 and 412 may be performed prior to a customer's arrival at a particular digital billboard device. For example, steps 411 and 412 may begin when a customer enters a retail location (e.g. store, mall). In some embodiments, aggregated and identified images may be stored in a database for later use. In some embodiments, digital billboard devices in a system that are idled (e.g. not actively engaging a customer) may perform steps 411 and 412 for one or more other digital billboard devices.

In step 421, the system selects an advertisement from the advertisement database to display to the customer. In some embodiments, the advertisement database may be a cloud-based database maintained by a remote server. In some embodiments, the advertisement database may be stored locally at the digital billboard device. In some embodiments, the digital billboard device may pre-load a subset of the advertisement database based on the location of the digital billboard. In some embodiments, the advertisement database stores a plurality of advertisements and display parameters associated with each of the plurality of advertisements. In some embodiments, the advertisement is selected based on one or more of customer demographics, customer location, customer social media activity, customer purchase history, estimated customer home inventory, date of the year, upcoming holidays, upcoming events, upcoming birthdays of the customer's social media connections, and upcoming anniversaries determined based on the customer's social media activity. In some embodiments, an advertisement may be selected based on the available types of images aggregated in step 411 an identified in 412. In some embodiments, the advertisement may be selected based on a set of selection parameters that are different from the display parameters for selecting customer images and used in step 422.

In step 422, the system selects at least one customer image from the plurality of images associated with the customer based on matching the display parameters of the advertisement in the advertisement database with the one or more characteristics of the plurality of images. For example, the advertisement's display parameters may specify that the image to be used in the advertisement should be an image of the customer themselves, an image of a customer's family member (e.g. mother, father), an image of a customer with two or more other friends, a specific object (e.g. car, tennis shoes), an image of an animal (e.g. family pet), an image of the customer at a specific location (e.g. restaurant, Hawaii, etc.), an image taken on a specific date (e.g. customer's birthday, thanksgiving, etc.) etc. The display parameter may generally be associated with any identifiable characteristics of an image and social media content. In step 422, the system selects at least one image identified in step 412 that matches the display parameters of the advertisement selected in step 421. In some embodiments, the display parameters of an advertisement may comprise a set of requirements which a customer image must meet to be selected. In some embodiments, the display parameters may comprise a set of preferences used to prioritize the customer images for display. For example, images may be accorded points based on how many preferences it meets, and the customer image with the highest match score may be selected. In some embodiments, the display parameters may comprise both requirements and preferences. In some embodiments, if no suitable customer images exist, the system may use a default/generic image to display the advertisement. In some embodiments, the system may select an advertisement based on comparing characteristics of available photos to the display parameters of advertisements in the database.

In step 431, the system merges the at least one customer image and an image of the advertisement to create a custom image advertisement for the customer. In some embodiments, the advertisement parameters may specify a display location and display dimension for the customer social media image within the advertisement. For example, in the image displayed in the digital billboard device 110 in FIG. 1, the image of the woman may be replaced with an image of a customer's mother received from a social media service. In some embodiments, the customer image may be modified, cropped, resized, and/or edited based on the advertisement parameters prior to being combined with the advertisement. For example, the customer's face may be cropped out of a larger picture to be used in the advertisement. In another example, customer's image may be color tone adjusted to match the advertisement. In some embodiments, the advertisement may comprise a video, and the location and dimension of the inserted image may be specified in multiple frames of the video such that the inserted image may move along with the content of the video. For example, a photo of the customer's face may be superimposed on a body that dances across the screen. In some embodiments, an advertisement may use two or more social media images of a customer simultaneously or sequentially.

In step 432, the system displays the custom image advertisement to the customer via the digital billboard device. In some embodiments, the displayed image may comprise a static image, video, interactive image, and the like. In some embodiments, the digital billboard may be configured to provide an option to the customer to download or share the customer image. In some embodiments, the digital billboard may communicate with a user device to share the custom image and/or other related promotional information with the user. In some embodiments, a central server and/or one or more other digital billboard devices may combine the images and send the image to a specific digital billboard based on the customer's anticipated movement. For example, a first digital billboard may identify the customer in step 401 and detect that the customer is walking to the other end of the aisle. The customer image may then be sent to a second billboard at the end of the aisle to display.

In some embodiments, after step 432, the system may use the customer sensor to determine whether the customer is still in the vicinity of the digital billboard. The system may repeat the steps in FIG. 4 to display another advertisement to the customer at the same location or on different digital billboards. In some embodiments, the system may simultaneously support multiple digital billboards to present customer advertisements to a plurality of customer. In some embodiments, if a customer is no longer near a digital billboard, the system may automatically remove the custom advertisement from that digital billboard.

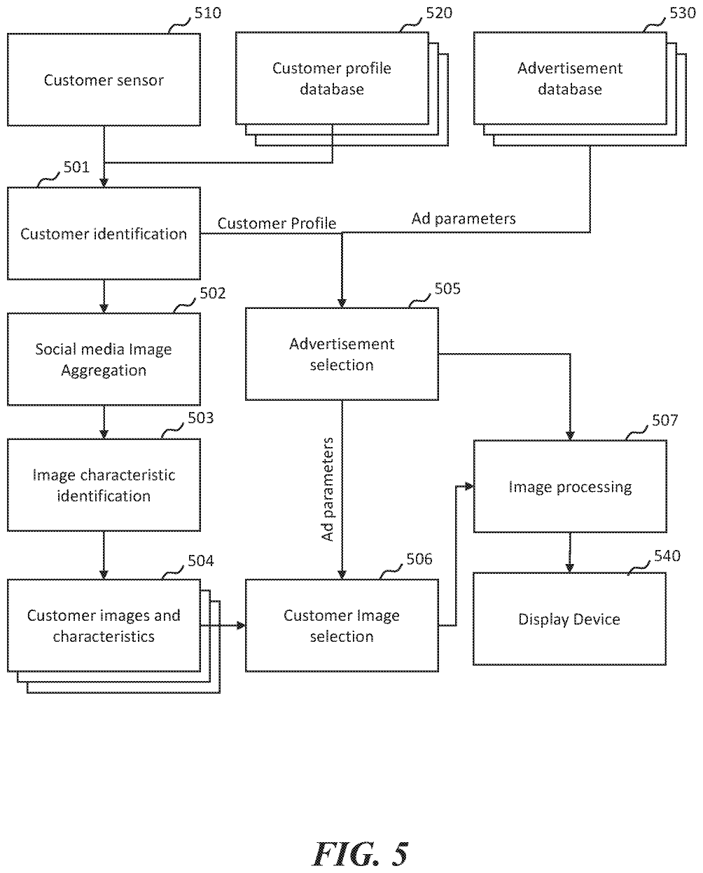

Referring next to FIG. 5, a process for providing customized advertisement display with a digital billboard is shown. In some embodiments, the steps in FIG. 5 may be performed by one or more of advertisement server 120, the digital billboard device 110, the digital billboard device 210, the advertisement server 320, and the digital billboard device 310 or similar devices.

The customer sensor 510 generally comprises a device configured to detect and identify a customer. In some embodiments, the customer sensor 510 may comprise one or more of an optical sensor, a presence sensor, a radio frequency identification (RFID) sensor, a near field communication (NFC) transceiver, a Wi-Fi transceiver, a Bluetooth transceiver, and the like. In some embodiments, the customer sensor 510 may comprise the customer sensor 214 or a similar device. In some embodiments, the customer sensor 510 may be integrated with the digital billboard device or be separately implemented. For example, the customer sensor 510 may comprise a camera system installed throughout a shopping space.

The customer identification module 501 is configured to use the information from the customer sensor 510 to identify the customer. The customer identification module may compare the information collected by the customer sensor (e.g. facial recognition, user device identifier, etc.) with customer profiles in the customer profile database 520 to identify the customer. In some embodiments, the customer identification module 501 may further be configured to determine whether a customer has authorized the use of social media images prior to proceeding. In some embodiments, the customer identification module 501 may be configured to perform step 401 described with reference to FIG. 4 herein.

The social media image aggregation module 502 is configured to aggregate images associated with the customer from one or more social media services. In some embodiments, the social media services correspond to content sharing services that the customer has linked with his/her account. In some embodiments, the social media image aggregation module 502 may only aggregate publicly accessible content on the user's social media. In some embodiments, the social media image aggregation module 502 may aggregate images uploaded by the customer, images associated with the customer (e.g. tagged, mentioned), and/or images uploaded or associated with accounts linked with the customer (e.g. friends, family, relatives). In some embodiments, the system may only aggregate recent image (e.g. within the last year, last 2 months, etc.) In some embodiments, the system may only aggregate featured images such as profile images, cover images, etc. In some embodiments, the social media image aggregation module 502 may be configured to aggregate images based on customer preferences and permissions associated with the customer account. In some embodiments, the social media image aggregation module 502 may be configured to perform step 411 described with reference to FIG. 4 herein.

The image characteristics identification module 503 is configured to identify one or more characteristics of the images aggregated by the social media image aggregation module 502. In some embodiments, the one or more characteristics are identified based on one or more of facial recognition, object recognition, and image metadata analysis. In some embodiments, the system may use annotations (e.g. description, tags, hashtags) and/or comments associated with the image to determine image characteristics. For example, if an image receives multiple comments with the word “engagement,” the system may determine that the photo is an engagement announcement. In some embodiments, the one or more characteristics of a customer image comprise one or more of persons, objects, date, location associated with the customer image. In some embodiments, the one or more characteristics of a customer image comprise a relationship with a person in the customer image as determined based on the customer's social media profile connections. The aggregated images and image characteristics are stored in the customer images and characteristics database 504. In some embodiments, image characteristics identification module 503 may be configured to perform step 412 described with reference to FIG. 4 herein.

The advertisement selection module 505 is configured to select one or more advertisements from the advertisement database 530 to display to the customer. In some embodiments, the advertisement may be selected based on a customer profile associated the customer identified by the customer identification module 501. In some embodiments, the advertisement may be selected based on one or more of customer demographics, customer location, customer social media activity, customer purchase history, estimated customer home inventory, date of the year, upcoming holidays, upcoming events, upcoming birthdays of the customer's social media connections, and upcoming anniversaries determined based on the customer's social media activity. In some embodiments, the advertisement may be selected based on the available images stored in the customer images and characteristics database 504. In some embodiments, the advertisement selection module 505 may be configured to perform step 421 described with reference to FIG. 4 herein.

The customer image selection module 506 is configured to select one or more customer images from the customer images and characteristics database 504 for the advertisement selected by the advertisement selection module 505. The selection may be based on comparing display parameters of the selected advertisement with the identified characteristics of the customer images. The display parameters of an advertisement may generally be associated with any identifiable characteristics of an image and social media content. In some embodiments, the display parameters of an advertisement may comprise a set of requirements which a customer image must meet to be selected. In some embodiments, the display parameters may comprise a set of preferences used to prioritize the customer images for display. For example, images may be accorded points based on how many preferences it meets, and the customer image with the highest match score may be selected. In some embodiments, the display parameters may comprise both requirements and preferences. In some embodiments, the customer image selection module 506 may be configured to perform step 422 described with reference to FIG. 4 herein.

The image processing module 507 is configured to combine advertisement images selected by the advertisement selection module 505 with the customer image selected by the customer image selection module 506 according to the advertisement's display parameters. In some embodiments, the advertisement parameters may specify a display location and display dimension for the customer social media image. In some embodiments, the customer image may be modified, cropped, resized, and/or edited based on the advertisement parameters prior to being combined with the advertisement. In some embodiments, the advertisement may comprise a video, and the location and dimension of the inserted image may be specified in multiple frames of the video such that the inserted image may move along with the content of the video. In some embodiments, an advertisement may use two or more social media images of a customer simultaneously or sequentially. In some embodiments, the image processing module 507 may comprise a graphics processing unit (GPU).

The customized image generated by the image processing module 507 is then provided to a display device 540 of a digital billboard device for display. In some embodiments, the display device 540 may comprise the display of the digital billboard device 110, the display device 213, the display device 311 or a similar device.

In some embodiments, one or more of the customer identification module 501, the social media image aggregation module 502, the image characteristics identification module 503, the advertisement selection module 505, the customer image selection module 506, and the image processing module 507 may comprise hardware modules (e.g. ASIC). In some, one or more of the customer identification module 501, the social media image aggregation module 502, the image characteristics identification module 503, the advertisement selection module 505, the customer image selection module 506, and the image processing module 507 may comprise software modules implemented on a server device and/or one or more digital billboard devices. In some embodiments, a digital billboard device may comprise one or more of the customer identification module 501, the social media image aggregation module 502, the image characteristics identification module 503, the advertisement selection module 505, the customer image selection module 506, and the image processing module 507. In some embodiments, one or more of the customer identification module 501, the social media image aggregation module 502, the image characteristics identification module 503, the advertisement selection module 505, the customer image selection module 506, and the image processing module 507 may be may be implemented in a server device that provides content to one or more digital billboards. In some embodiments, the customer identification module 501, the advertisement selection module 505, the customer image selection module 506, and the image processing module 507 may be implemented on a digital billboard device while the social media image aggregation module 502 and the image characteristics identification module 503 may be implemented on a server. For example, a digital billboard may store a set of advertisements relevant to its location, and download customer images from a server to merge with the selected advertisement. In some embodiments, one or more of the customer identification module 501, the social media image aggregation module 502, the image characteristics identification module 503, the advertisement selection module 505, the customer image selection module 506, and the image processing module 507 may be implemented on a plurality of devices that collectively generate customized images for display. For example, one or more digital billboard devices may be configured to aggregate social images and perform object recognition on the images when the device is idle, and supply image information and/or generate customer advertisement content for other digital billboard devices to display.

Delivering customer-centric messages designed to entice the customer can encourage the purchase of products and services. In conventional advertisements, messages are generally generic. Although the intent is often to engage the individual with something that is heartfelt, it is difficult to do so with generic messages.

In some embodiments, the systems described herein provide a relatable form of interaction with customers through advertisements. Instead of seeing an actor or actress demonstrating a product on a digital sign, the customer image is embedded into the advertisement itself, for example, featuring the customer using the product. In a specific example, if Bob were to walk by a product advertisement, Bob would be featured using the product. In another example, if Bob walks by a sign for an advertisement for Valentine's (e.g. a ring or jewelry) the sign may send a personal message to Bob, reminding him of Valentine's day, and may even feature a special message reminding him of that special someone in his life (e.g. “Bob, how about this ring for Patty this Valentine's day?”). In another example, the tailored message for Bob featuring Patty may also feature Patty's visuals. For example, Patty may be featured wearing the ring. Some embodiments described herein provide immersive and personal messages to connect with the customer in a way that provides a relevant aid in suggesting products specific to them.

In some embodiments, instead of using a generic message for a general audience, such as, “Have you tried this today?” the system may create messages specific to the customer when they are near a sign. For instance, when Bob walks by the pain medication aisle in his local store, digital signage above the shelving may initial display advertisements of Tylenol. When Bob walks closer to the sign, the sign may change to say “Bob, we have a special on Tylenol today and your household inventory is running low.”

In some embodiments, the systems described herein are configured provide personalized digital signage through smart device identification. The digital signage may sync with a user's smart device when they are in close proximity. After the smart device and the digital signage are synced, information specific and centric to the customer may be passed to their smart device or may create a message specific to the customer on the signage itself. In some embodiments, the system may comprise a geofence, which determines when a customer is in the vicinity of a signage to initiate the process. When a smart device enters the vicinity of the digital signage, the system may determine the customer associated with the smart device and retrieve customer information from the cloud. When the digital signage receives customer profile information, the system is configured to create and displays specific messages for the customer that are tailored to the customer based on the customer's profile using artificial intelligence. In some embodiments, the displayed message may comprise text or audio messages (e.g. “Hey Bob, you are running low on Equate toothpaste”). In some embodiments, the displayed message may comprise videos or visual messages that use the customer's social media image. For example, a photograph of the customer may be superimposed over a video of an actor or actress driving a car to display the customer behind the wheel. In some embodiments, the message may comprise household or office inventory messages. For example, when the customer is near an item he/she regularly purchases, the last purchase date of the item or the estimated household inventory may be displayed to remind the customer to restock.

In some embodiments, systems may provide personalized digital signage through visual or video analytics. When a customer is in near a digital signage, the system may identify the customer through facial recognition and displayed tailored messages specific to the customer. In some embodiments, the digital signage may capture images of customers within its vicinity or line of sight continuously. When a customer enters the vicinity of digital signage, the digital signage may identify the customer and retrieve the customer's profile from the cloud. The digital signage may then generate and display customized messages to the customer.

In some embodiments, the customer may engage with the digital signage. In some embodiments, the digital signage may be configured to receive, process, and store the customer's responses and facial expressions. For example, through facial expression, audio response, and text-based analytics. Audio and text information may be collected through the customer's user device (e.g. smartphone messaging application). The analysis may be captured and stored to improve future selection of advertisements.

In some embodiments, customers may access and share information displayed on digital signage through social media outlets, texting, etc. For example, when an image of the customer interacting with a product is displayed, the image may be transmitted to the customer's device, such as a smart device, where it can be stored and shared with social media outlets. In a specific example when a customer is shown riding a bicycle in a digital signage display they can view the image or video on a mobile application associated with the digital signage and share the image on their preferred social media outlet. The application may further allow the customer to modify the images with captions, perform photo adjustments, etc. (e.g. “I want this Bicycle for Christmas).

In some embodiments, A system for providing customized advertisement display comprises a digital billboard device comprising a customer sensor, a communication device configured to communicate with a plurality of social media services, an advertisement database storing a plurality of advertisements and display parameters associated with each of the plurality of advertisements, and a control circuit coupled to the digital billboard device, the communication device, and the advertisement database. The control circuit being configured to identify a customer near the digital billboard device via a customer sensor, aggregate a plurality of images associated with the customer from the plurality of social media services via the communication device, identify one or more characteristics of each of the plurality of images associated with the customer, select an advertisement from the advertisement database to display to the customer, select at least one customer image from the plurality of images associated with the customer based on matching the display parameters of the advertisement in the advertisement database with the one or more characteristics of the plurality of images, merge the at least one customer image and an image of the advertisement to create a custom image advertisement for the customer, and display the custom image advertisement to the customer via the digital billboard device.

In one embodiment, a method for providing customized advertisement display, comprises identifying a customer near a digital billboard device via a customer sensor of the digital billboard device, aggregating, at a control circuit, a plurality of images associated with the customer from the plurality of social media services via a communication device configured to communicate with a plurality of social media services, identifying, with the control circuit, one or more characteristics of each of the plurality of images associated with the customer, selecting, with the control circuit, an advertisement from an advertisement database to display to the customer, wherein the advertisement database stores a plurality of advertisements and display parameters associated with each of the plurality of advertisements, selecting, with the control circuit, at least one customer image from the plurality of images associated with the customer based on matching the display parameters of the advertisement in the advertisement database with the one or more characteristics of the plurality of images, merging the at least one customer image and an image of the advertisement to create a custom image advertisement for the customer, and displaying the custom image advertisement to the customer via the digital billboard device.

In one embodiment, an apparatus for providing customized advertisement display, comprises a non-transitory storage medium storing a set of computer readable instructions and a control circuit configured to execute the set of computer readable instructions which causes to the control circuit to: identify a customer near a digital billboard device via a customer sensor of the digital billboard device, aggregate a plurality of images associated with the customer from the plurality of social media services via a communication device configured to communicate with a plurality of social media services, identify one or more characteristics of each of the plurality of images associated with the customer, select an advertisement from an advertisement database to display to the customer, wherein the advertisement database stores a plurality of advertisements and display parameters associated with each of the plurality of advertisements, select at least one customer image from the plurality of images associated with the customer based on matching the display parameters of the advertisement in the advertisement database with the one or more characteristics of the plurality of images, merge the at least one customer image and an image of the advertisement to create a custom image advertisement for the customer, and display the custom image advertisement to the customer via the digital billboard device.

In some embodiments, one or more of the exemplary embodiments of the system for providing customized content include one or more localized (Internet of Things) IoT devices and controllers. For example, one or more of the digital billboards and user devices in may comprise IoT devices. As a result, in an exemplary embodiment, the localized IoT devices and controllers can perform most, if not all, of the computational load and associated monitoring and then later asynchronous uploading of summary data can be performed by a designated one of the IoT devices to a remote server. In this manner, the computational effort of the overall system may be reduced significantly. For example, whenever a localized monitoring allows remote transmission, secondary utilization of controllers keeps securing data for other IoT devices and permits periodic asynchronous uploading of the summary data to the remote server. In addition, in an exemplary embodiment, the periodic asynchronous uploading of summary data may include a key kernel index summary of the data as created under nominal conditions. In an exemplary embodiment, the kernel encodes relatively recently acquired intermittent data (“KRI”). As a result, in an exemplary embodiment, KRI includes a continuously utilized near term source of data, but KRI may be discarded depending upon the degree to which such KM has any value based on local processing and evaluation of such KRI. In an exemplary embodiment, KRI may not even be utilized in any form if it is determined that KM is transient and may be considered as signal noise. Furthermore, in an exemplary embodiment, the kernel rejects generic data (“KRG”) by filtering incoming raw data using a stochastic filter that provides a predictive model of one or more future states of the system and can thereby filter out data that is not consistent with the modeled future states which may, for example, reflect generic background data. In an exemplary embodiment, KRG incrementally sequences all future undefined cached kernels of data in order to filter out data that may reflect generic background data. In an exemplary embodiment, KRG incrementally sequences all future undefined cached kernels having encoded asynchronous data in order to filter out data that may reflect generic background data.

Those skilled in the art will recognize that a wide variety of modifications, alterations, and combinations can be made with respect to the above described embodiments without departing from the scope of the invention, and that such modifications, alterations, and combinations are to be viewed as being within the ambit of the inventive concept.

What is claimed is:

1. A system for providing customized advertisement display, comprising:
a digital billboard device comprising a customer sensor;
a communication device configured to communicate with a plurality of social media services;
an advertisement database storing a plurality of advertisements and display parameters associated with each of the plurality of advertisements;
a control circuit coupled to the digital billboard device, the communication device, and the advertisement database, the control circuit being configured to:
identify a customer near the digital billboard device via the customer sensor;
aggregate a plurality of images associated with the customer from the plurality of social media services via the communication device;
identify one or more characteristics of each of the plurality of images associated with the customer;
select an advertisement from the advertisement database to display to the customer;
select at least one customer image from the plurality of images associated with the customer based on matching the display parameters of the advertisement in the advertisement database with the one or more characteristics of the plurality of images;
merge the at least one customer image and an image of the advertisement to create a custom image advertisement for the customer; and
display the custom image advertisement to the customer via the digital billboard device.

2. The system of claim 1, wherein the one or more characteristics are identified based on one or more of facial recognition, object recognition, and image metadata analysis.

3. The system of claim 1, wherein the one or more characteristics of a customer image comprise one or more of persons, objects, date, location, or event associated with the customer image.

4. The system of claim 1, wherein the one or more characteristics of a customer image comprise a relationship with a person in the customer image as determined based on the customer's social media profile connections.

5. The system of claim 1, wherein the advertisement is selected based on one or more of customer demographics, customer location, customer social media activity, customer purchase history, estimated customer home inventory, date of the year, upcoming holidays, upcoming events, upcoming birthdays of the customer's social media connections, and upcoming anniversaries determined based on the customer's social media activity.

6. The system of claim 1, wherein the display parameters associated with each of the plurality of advertisements comprise one or more of required customer image characteristics, preferred customer image characteristics, and customer image insertion location.

7. The system of claim 1, wherein the customer sensor comprises a camera, and the control circuit is configured to perform facial recognition to identify the customer.

8. The system of claim 1, wherein the customer sensor comprises a wireless transceiver configured to communicate with a mobile device carried by the customer to identify the customer.

9. The system of claim 8, wherein the customer sensor is configured to communicate with the mobile device via a mobile application installed on the mobile device, and the mobile application allows the customer to opt-in and/or opt-out of the custom image advertisement.

10. The system of claim 8, wherein the customer sensor is configured to communicate the custom image advertisement and/or information associated with an advertised product to the mobile device.

11. A method for providing customized advertisement display, comprising:
identifying a customer near a digital billboard device via a customer sensor of the digital billboard device;
aggregating, at a control circuit, a plurality of images associated with the customer from a plurality of social media services via a communication device configured to communicate with the plurality of social media services;
identifying, with the control circuit, one or more characteristics of each of the plurality of images associated with the customer;
selecting, with the control circuit, an advertisement from an advertisement database to display to the customer, wherein the advertisement database stores a plurality of advertisements and display parameters associated with each of the plurality of advertisements;
selecting, with the control circuit, at least one customer image from the plurality of images associated with the customer based on matching the display parameters of the advertisement in the advertisement database with the one or more characteristics of the plurality of images;
merging the at least one customer image and an image of the advertisement to create a custom image advertisement for the customer; and
displaying the custom image advertisement to the customer via the digital billboard device.

12. The method of claim 11, wherein the one or more characteristics a customer image are identified based on one or more of facial recognition, object recognition, and image metadata analysis.

13. The method of claim 11, wherein the one or more characteristics of a customer image comprise one or more of persons, objects, date, location, or event associated with the customer image.

14. The method of claim 11, wherein the one or more characteristics of a customer image comprise a relationship with a person in the customer image as determined based on the customer's social media profile connections.

15. The method of claim 11, wherein the advertisement is selected based on one or more of customer demographics, customer location, customer social media activity, customer purchase history, estimated customer home inventory, date of the year, upcoming holidays, upcoming events, upcoming birthdays of the customer's social media connections, and upcoming anniversaries determined based on the customer's social media activity.

16. The method of claim 11, wherein the display parameters associated with each of the plurality of advertisements comprise one or more of required customer image characteristics, preferred customer image characteristics, and customer image insertion location.

17. The method of claim 11, wherein the customer sensor comprises a camera, and the control circuit is configured to perform facial recognition to identify the customer.

18. The method of claim 11, wherein the customer sensor comprises a wireless transceiver configured to communicate with a mobile device carried by the customer to identify the customer.

19. The method of claim 18, wherein the customer sensor is configured to communicate with the mobile device via a mobile application installed on the mobile device, and the mobile application allows the customer to opt-in and/or opt-out of the custom image advertisement.

20. An apparatus for providing customized advertisement display, comprising:
a non-transitory storage medium storing a set of computer readable instructions; and
a control circuit configured to execute the set of computer readable instructions which causes to the control circuit to:
identify a customer near a digital billboard device via a customer sensor of the digital billboard device;
aggregate a plurality of images associated with the customer from a plurality of social media services via a communication device configured to communicate with the plurality of social media services;
identify one or more characteristics of each of the plurality of images associated with the customer;
select an advertisement from an advertisement database to display to the customer, wherein the advertisement database stores a plurality of advertisements and display parameters associated with each of the plurality of advertisements;
select at least one customer image from the plurality of images associated with the customer based on matching the display parameters of the advertisement in the advertisement database with the one or more characteristics of the plurality of images;
merge the at least one customer image and an image of the advertisement to create a custom image advertisement for the customer; and
display the custom image advertisement to the customer via the digital billboard device.
